(19) United States
(12) Patent Application Publication
(10) Pub. No.: US 2015/0142755 A1
(43) Pub. Date: May 21, 2015

(54) STORAGE APPARATUS AND DATA MANAGEMENT METHOD

(71) Applicant: Masayuki Kishi, Nakai (JP)

(72) Inventor: Masayuki Kishi, Nakai (JP)

(73) Assignees: HITACHI, LTD., Tokyo (JP); HITACHI INFORMATION & TELECOMMUNICATION ENGINEERING, LTD., Kanagawa (JP)

(21) Appl. No.: 14/117,736

(22) PCT Filed: Aug. 24, 2012
(86) PCT No.: PCT/JP2012/071424

§ 371 Date: Nov. 14, 2013

(51) Int. Cl. G06F 17/30

(52) U.S. Cl. CPC G06F 17/30371; G06F 17/30117
USPC 707/692

(57) ABSTRACT

A control unit of a storage apparatus divides received data into one or more chunks and compresses the divided chunk(s); and regarding the chunk whose compressibility is equal to or lower than a threshold value, the control unit does not store the chunk in the first storage area, but calculates a hash value of the compressed chunk, compares the hash value with a hash value of another data already stored in the second storage area and executes first deduplication processing; and regarding the chunk whose compressibility is higher than the threshold value, the control unit stores the compressed chunk in the first storage area, reads the compressed chunk from the first storage area, calculates a hash value of the compressed chunk, compares the relevant hash value with a hash value of another data already stored in the second storage area, and executes secondary deduplication processing.

### TECHNICAL FIELD

The present invention relates to a storage apparatus and data management method and is suited for application to a storage apparatus and data management method for executing deduplication processing by using two or more deduplication mechanisms.

### BACKGROUND ART

Storage apparatuses retain large-capacity storage areas in order to store large-scale data from host systems. Data from the host systems have been increasing every year and it is necessary to store the large-scale data efficiently due to problems of the size and cost of the storage apparatuses. So, attention has been focused on data deduplication processing for detecting and eliminating data duplications in order to curb the growth of the data amount to be stored in the storage areas and enhance data capacity efficiency.

The data deduplication processing is a technique that does not write duplicate data to a magnetic disk if the content of the data to be newly written to a storage device, that is, so-called write data, is identical to that of data already stored in the magnetic disk. Whether or not the content of the write data is identical to that of the data which is already stored in the magnetic disk is generally verified by using hash values of the data.

Conventionally, a method of storing all pieces of data from a host system in a disk and then executing deduplication processing (hereinafter sometimes referred to as the post-process method) has been adopted. However, since the post-process method requires writing of all pieces of data from the host system in the disk, a large-capacity storage area is needed. Accordingly, a technique that executes the deduplication processing by using not only the post-process method, but also a method of executing the deduplication processing before writing data to the disk (hereinafter sometimes referred to as the in-line method) is disclosed (for example, Patent Literature 1).

### CITATION LIST

### Patent Literature

[Patent Literature 1] US 2011/0289281 A1

### SUMMARY OF INVENTION

### Problems to be Solved by the Invention

Patent Literature 1 discloses simply only the combined use of the post-process method and the in-line method during the deduplication processing. However, since all pieces of data are written to the disk once by the post-process method, the entire processing performance depends on write performance of the disk. Furthermore, by the in-line method, the deduplication processing is executed when writing data to the disk, so that the entire processing performance depends on the performance of the deduplication processing. Therefore, it is necessary to execute the deduplication processing in consideration of advantages of both the methods. Also, in a case of the combined use of the post-process method and the in-line method, the same deduplication processing is executed by both the methods, thereby causing a problem of the possible occurrence of wasteful deduplication processing.

Therefore, it is intended to suggest a storage apparatus and data management method capable of executing deduplication processing efficiently in consideration of advantages of two or more deduplication mechanisms.

### Means for Solving the Problems

In order to solve the above-described problems, the present invention provides a storage apparatus including: a storage device providing a first storage area and a second storage area; and a control unit for controlling data input to and output from the storage device; wherein the control unit divides received data into one or more chunks, and compresses the divided chunk or chunks; and regarding the chunk whose compressibility is equal to or lower than a threshold value, the control unit does not store the chunk in the first storage area, but calculates a hash value of the compressed chunk, compares the hash value with a hash value of another data already stored in the second storage area, and executes first deduplication processing; and regarding the chunk whose compressibility is higher than the threshold value, the control unit stores the compressed chunk in the first storage area, then reads the compressed chunk from the first storage area, calculates a hash value of the compressed chunk, compares the relevant hash value with a hash value of another data already stored in the second storage area, and executes secondary deduplication processing.

According to the above-described configuration, the received data is divided into one or more chunks and the divided chunk(s) is compressed; and if the compressibility of the chunk is equal to or lower than a specified threshold value, a hash value of the relevant chunk is calculated, the hash value is compared with a hash value of already stored data, and the first deduplication processing is executed; and if the compressibility of the chunk is higher than the specified threshold value, the relevant compressed chunk is stored in the first file system, and then a hash value of the compressed chunk is calculated, the relevant hash value is compared with a hash value of already stored data, and the secondary deduplication processing is executed.

As a result, the processing of the deduplication processing for dividing data with a small processing load can be executed during the primary deduplication processing; and whether the relevant chunk should be deduplicated by the primary deduplication processing or the deduplication processing should be executed by the secondary deduplication processing can be decided based on the compressibility of the chunk. So, the deduplication processing can be executed efficiently in consideration of the respective advantages of the primary deduplication processing and the secondary deduplication processing.

### Advantageous Effects of Invention

The load of the deduplication processing can be distributed according to the present invention by efficiently executing the deduplication processing in consideration of the advantages of two or more deduplication mechanisms.

### BRIEF DESCRIPTION OF DRAWINGS

FIG. 1 is a conceptual diagram for explaining the outline of a first embodiment of the present invention.

FIG. 2 is a block diagram depicting a hardware configuration of a computer system according to the embodiment.

FIG. 3 is a block diagram depicting a software configuration of a storage apparatus according to the embodiment.

FIG. 4 is a chart for explaining metadata according to the embodiment.

FIG. 5 is a conceptual diagram for explaining chunk management information according to the embodiment.

FIG. 6 is a conceptual diagram depicting primary deduplicated data according to the embodiment.

FIG. 7 is a chart for explaining a compression header for a chunk(s) according to the embodiment.

FIG. 8 is a flowchart illustrating backup processing according to the embodiment.

FIG. 9 is a flowchart illustrating data write processing according to the embodiment.

FIG. 10 is a flowchart illustrating primary deduplication processing according to the embodiment.

FIG. 11 is a flowchart illustrating secondary deduplication processing according to the embodiment.

FIG. 12 is a flowchart illustrating data read processing according to the embodiment.

FIG. 13 is a flowchart illustrating data read processing according to the embodiment.

FIG. 14 is a block diagram depicting a software configuration of a storage apparatus according to a second embodiment of the present invention.

### DESCRIPTION OF EMBODIMENTS

One embodiment of the present invention will be described below in detail with reference to the drawings.

### (1) First Embodiment

### (1-1) Outline of this Embodiment

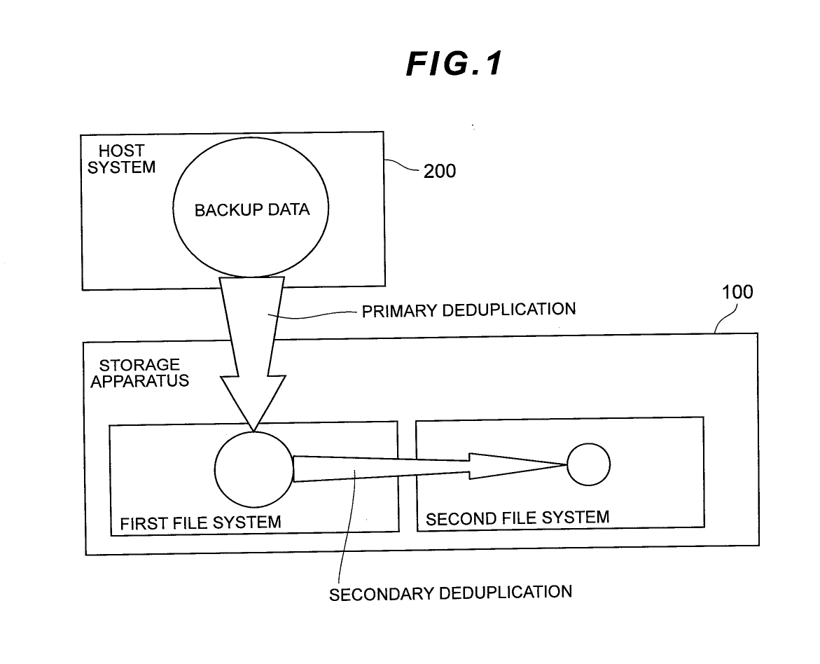

Firstly, the outline of this embodiment will be explained with reference to FIG. 1. In this embodiment, a storage apparatus 100 stores backup data from a host system 200 in its storage areas. Incidentally, the host system may be a server such as a backup server, or another storage apparatus. The storage apparatus 100 includes, as the storage areas for the backup data, a storage area for temporarily storing the backup data (first file system) and a storage area of the backup data after the execution of deduplication processing (second file system).

When storing the backup data in the first file system, the storage apparatus 100 executes first deduplication processing (hereinafter referred to as the primary deduplication processing). A method of executing the deduplication processing before storing the backup data from the host system 200 in this way is called the in-line method.

Then, the storage apparatus 100 further executes deduplication processing on the backup data stored in the first file system (hereinafter referred to as the secondary deduplication processing) and stores the backup data in the second file system. A method of executing the deduplication processing after storing the backup data once is called the post-process method.

All pieces of data are written to a disk once by the post-process method, so that the entire processing performance depends on write performance of the disk. Also, all pieces of data are written to the disk once by the post-process method, so that a large storage capacity for storing the data is consumed. Furthermore, the deduplication processing is executed when writing data to the disk by the in-line method, so that the entire processing performance depends on performance of the deduplication processing. Therefore, it is necessary to execute the deduplication processing in consideration of the advantages of both the methods. Furthermore, in the case of the combined use of the post-process method and the in-line method, the same deduplication processing is executed by both the methods, thereby causing a problem of the possible occurrence of wasteful deduplication processing.

Therefore, in this embodiment, whether data should be deduplicated by the primary deduplication processing or the deduplication processing should be executed by the secondary deduplication processing is decided based on compressibility of the data. Furthermore, processing of the deduplication processing for dividing data with a small processing load is executed at the time of the primary deduplication processing. As a result, it is possible to execute the deduplication processing efficiently in consideration of the respective advantages of the primary deduplication processing and the secondary deduplication processing. Also, since the primary deduplication processing is executed only on data whose compressibility is lower than a threshold value, it is possible to reduce the processing load imposed by the in-line method and also reduce a consumption amount of the storage area for temporarily storing the data.

### (1-2) Configuration of Computer System

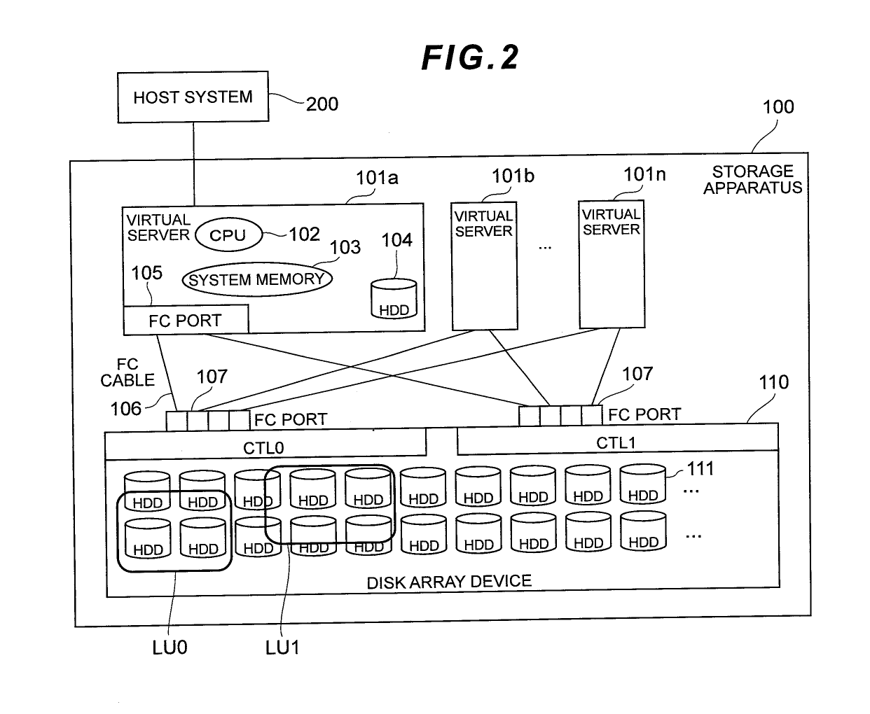

Next, a hardware configuration of a computer system according to this embodiment will be explained. The computer system includes a storage apparatus 100 and a host system 200 as depicted in FIG. 2. The host system 200 is connected to the storage apparatus 100 via a network such as a SAN (Storage Area Network). Incidentally, a management terminal for controlling the storage apparatus 100 may be included although it is not depicted in the drawing.

The storage apparatus 100 interprets commands sent from the host system 200 and reads/writes them from/to the storage areas in a disk array device 110. The storage apparatus 100 includes a plurality of virtual servers 101a, 101b, 101c, and so on up to 101n (hereinafter sometimes collectively referred to as the virtual server 101), a Fibre Channel cable (indicated as an FC cable in the drawing) 106, and the disk array device 110. The virtual server 101 and the disk array device 110 are connected via a Fibre Channel cable 106 connected to Fibre Channel ports 105, 107. Incidentally, the virtual servers are used in this embodiment, but physical servers may be used.

The virtual server 101 is a virtually reproduced computer environment in the storage apparatus 100. The virtual server 101 includes, for example, a CPU 102, a system memory 103, an HDD (Hard Disk Drive) 104, and a Fibre Channel port (indicated as an FC port in the drawing) 105.

The CPU 102 functions as a processor controller and controls the operation of the entire storage apparatus 100 in accordance with various program and arithmetic parameters stored in the system memory 103. The system memory 103 mainly stores programs for executing the primary deduplication processing and programs for executing the secondary deduplication processing.

The HDD 104 is composed of a plurality of storage media. For example, the HDD 104 may be composed of expensive hard disk drives such as SSD's (Solid State Disks) and SCSI (Small Computer System Interface) disks or inexpensive hard disk drives such as SATA (Serial AT Attachment) disks. Incidentally, the HDDs are used as storage media in this embodiment, but other storage media such as SSD's may be used.

A plurality of HDDs 104 constitutes one RAID (Redundant Array of Inexpensive Disks) group and one or more logical units (LU's) are set in physical storage areas provided by one or more RAID groups. Then, data from the host system 200 are stored in blocks, each of which is of a specified size as a unit, in the logical unit(s) (LU). In this embodiment, LU0 constituted from a plurality of HDD's 104 of the disk array device 110 is mounted on the first file system and LU1 is mounted on the second file system.

The host system 200 is a computer device equipped with an arithmetic unit such as a CPU (Central Processing Unit) and information processing resources such as storage areas like memories and disks, as well as information input/output devices such as a keyboard, a mouse, a monitor display, a speaker, and a communication I/F card, if necessary; and is composed of, for example, a personal computer, a workstation, or a mainframe.

### (1-3) Software Configuration of Storage Apparatus

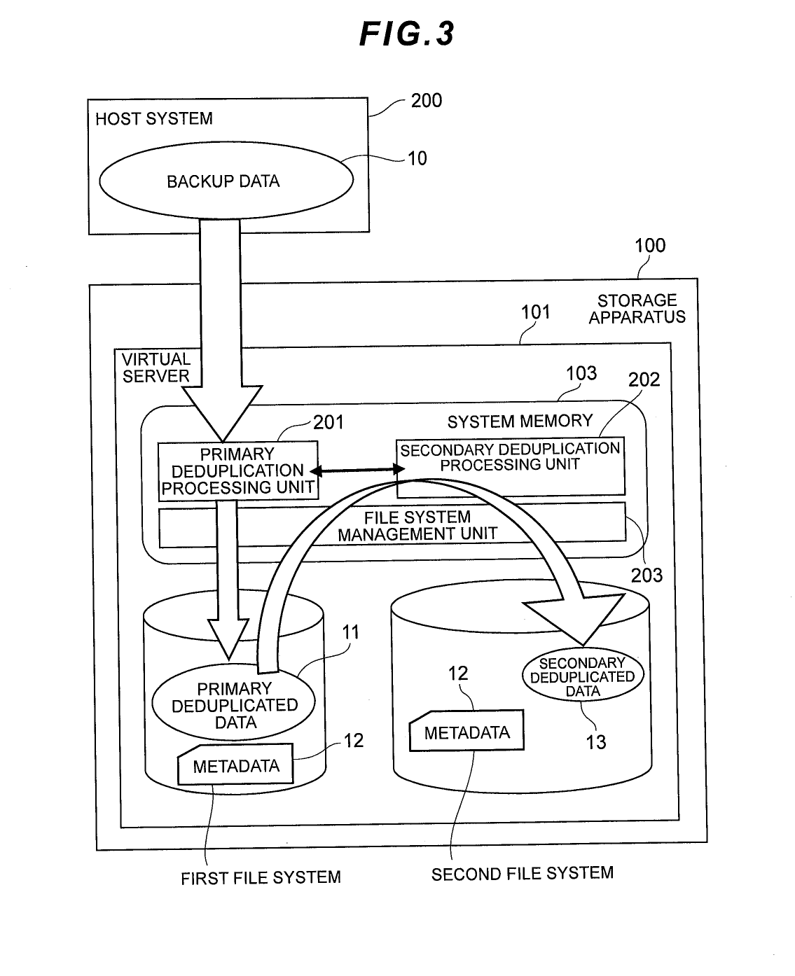

Next, a software configuration of the storage apparatus 100 will be explained with reference to FIG. 3. The system memory 103 of the storage apparatus 100 stores programs such as a primary deduplication processing unit 201, a secondary deduplication processing unit 202, and a file system management unit 203 as shown in FIG. 3. Incidentally, these programs are executed by the CPU. Therefore, when any of these programs is mentioned as a subject when explaining processing in the following explanation, it means that the processing is actually implemented by the CPU executing the relevant program.

The primary deduplication processing unit 201 executes the primary deduplication of backup data 10 from the host system 200 and stores it in the first file system. The secondary deduplication processing unit 202 executes the secondary deduplication of primary deduplicated data 11 stored in the first file system and stores it in the second file system.

In this embodiment, the primary deduplication processing executed by the primary deduplication processing unit 201 and the secondary deduplication processing executed by the secondary deduplication processing unit 202 execute different procedures of deduplication processing. The primary deduplication processing executes processing for dividing data with a small load and processing for compressing the data during the deduplication processing. Also, whether a calculation of a hash value of the data and the deduplication processing should be executed by the primary deduplication processing or the secondary deduplication processing is judged based on compressibility of the data after the compression processing. Then, during the secondary deduplication processing, the deduplication processing is executed on data for which the hash value calculation has not been performed by the primary deduplication processing.

If the primary deduplication processing, which is the in-line mend, is executed on all pieces of the backup data as described above, it takes time to execute the deduplication processing and the processing performance of the entire storage apparatus 100 depends on the performance of the deduplication processing. Also, if all pieces of the backup data are deduplicated by the post-process method, that is, if all pieces of the backup data are stored in the first file system once and then the deduplication processing is executed on the backup data by the secondary deduplication processing, the entire processing performance depends on write performance of the relevant disk. Furthermore, since all pieces of data are written to the disk once by the post-process method, a large storage capacity for storing the data is consumed. Moreover, the same deduplication processing is executed by both the primary deduplication processing and the secondary deduplication processing simply by only using the combination of the primary deduplication processing and the secondary deduplication processing, which results in the occurrence of wasteful deduplication processing.

Therefore, in this embodiment, the primary deduplication processing performs the processing for dividing data with a small load and the compression processing of the deduplication processing and further executes duplication judgment processing on the divided data of low compressibility (data which consumes a large capacity of the temporary data storage area). The data divided by the primary deduplication processing will be hereinafter referred to as the chunk(s) in the following explanation. The data division processing will be explained later in detail.

The duplication judgment processing of the deduplication processing requires almost the same amount of time regardless of the compressibility of the divided data (chunks). Therefore, as a result of the execution of the duplication judgment processing on a chunk(s) of low compressibility during the primary deduplication processing, it is possible to reduce the load imposed by the duplication judgment processing and increase the speed of data write processing. Furthermore, the consumption amount of the storage area for temporarily storing data can be reduced by executing the deduplication processing on the chunk(s) of the low compressibility by the in-line method.

On the other hand, during the secondary deduplication processing, the duplication judgment processing is executed on chunks other than the chunks, on which the duplication judgment processing has already been executed by the primary deduplication processing, thereby preventing the execution of the same deduplication processing by the primary deduplication processing and the secondary deduplication processing. Specifically speaking, regarding the chunks on which the duplication judgment processing was executed by the primary deduplication processing, a flag indicating that the duplication judgment processing has already been executed is set to a data header of each chunk. Then, during the secondary deduplication processing, the duplication judgment processing is executed on a chunk(s), on which the duplication judgment processing has not been executed by the primary deduplication processing, by referring to the set flag.

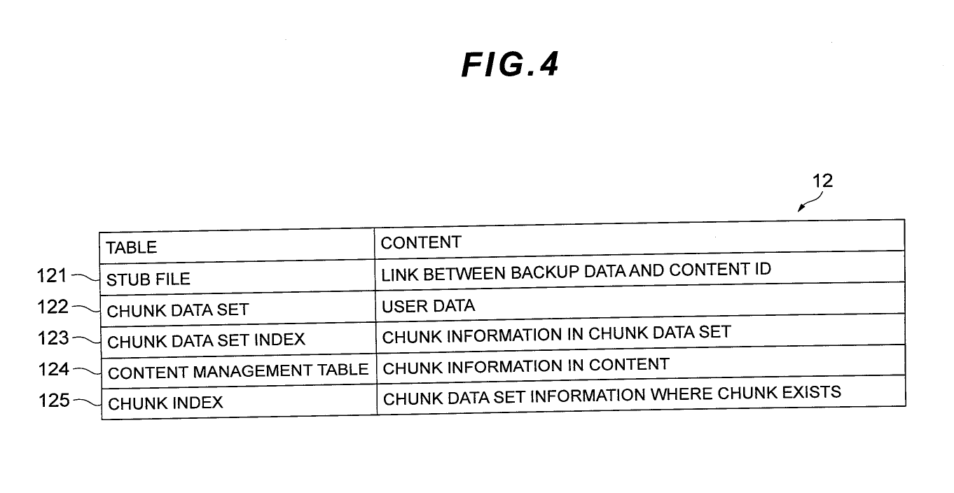

Next, metadata 12 which is stored in the first file system and the second file system will be explained with reference to FIG. 4. The metadata 12 is data indicating management information of primary deduplicated data stored in the first file system or secondary deduplicated data stored in the second file system.

The metadata 12 includes various tables as shown in FIG. 4. Specifically speaking, the metadata 12 includes tables such as a stub file (Stub file) 121, a chunk data set (Chunk Data Set) 122, a chunk data set index (Chunk Data Set Index) 123, a content management table 124, and a chunk index 125.

The stub file 121 is a table for associating backup data with a content ID. The backup data is composed of a plurality of pieces of file data. The relevant file data will be referred to as the logically gathered content (content) that is a unit to be stored in the storage area. Each piece of content is divided into a plurality of chunks and each piece of content is identified with the content ID. This content ID is stored in the stub file 121. When the storage apparatus 100 reads/writes data stored in the disk array device 110, the content ID of the stub file 121 is firstly invoked.

The chunk data set 122 is user data composed of a plurality of chunks and is backup data stored in the storage apparatus 100. The chunk data set index 123 stores information of each chunk included in the chunk data set 122. Specifically speaking, the chunk data set index 123 stores length information of each chunk and chunk data by associating them with each other.

The content management table 124 is a table for managing chunk information in the content. The content herein used means file data identified with the aforementioned content ID. Furthermore, the chunk index 125 is information indicating in which chunk data set 122 each chunk exists. Also, the chunk index 125 is associated with a fingerprint of the relevant chunk for identifying each chunk and a chunk data set ID for identifying the chunk data set 122 where the relevant chunk exists.

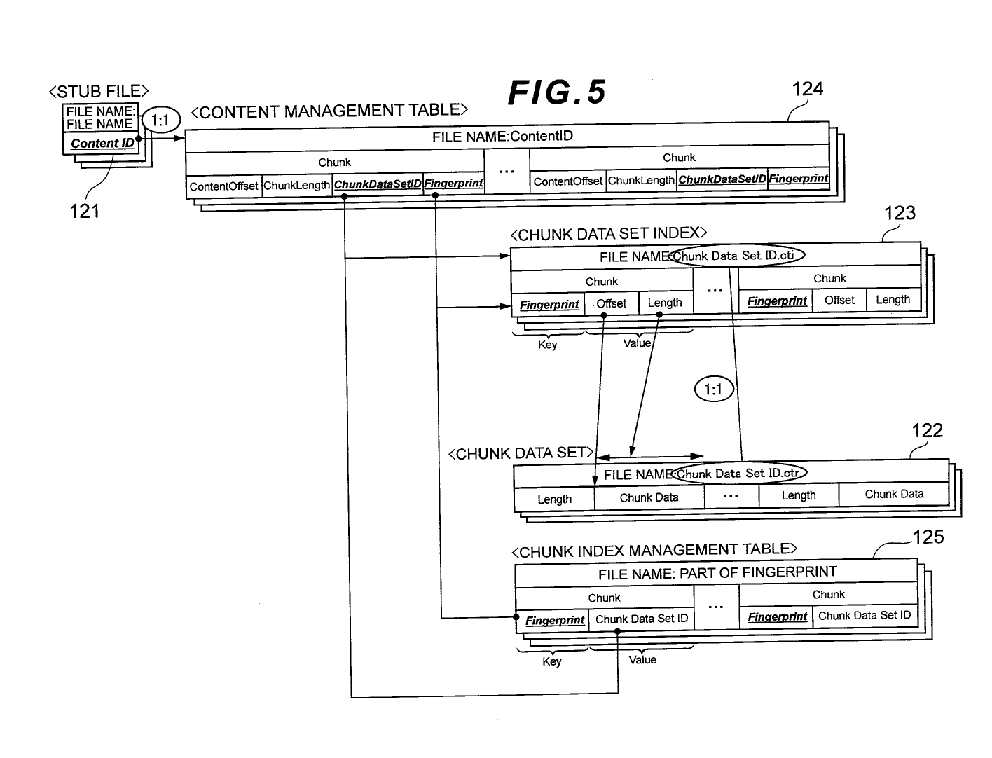

Next, the chunk management information will be explained in detail with reference to FIG. 5. The stub file (indicated as Stub File in the drawing) 121 stores a content ID (indicated as Content ID in the drawing) for identifying an original data file as shown in FIG. 5. Then, one content file corresponds to one stub file 121 and each content file is managed by the content management table (indicated as Content Mng Tbl in the drawing) 124.

Each content file managed by the content management table 124 is identified with the content ID (indicated as Content ID in the drawing). The content file stores offset (Content Offset) of each chunk, chunk length (Chunk Length), identification information (Chunk Data Set ID) of a container where the relevant chunk exists, and a hash value (Fingerprint) of each chunk.

Furthermore, the chunk data set index (indicated as Chunk Data Set Index in the drawing) 123 stores, as chunk management information, hash values (Fingerprint) of chunks stored in the chunk data set (indicated as Chunk Data Set in the drawing) 122 and the offset and data length of the relevant chunks by associating them with each other. Each chunk data set 122 is identified with a chunk data set ID (indicated as Chunk Data Set ID in the drawing). The chunk data set index 123 collects and manages the management information of the chunk on a chunk data set basis.

The chunk data set 122 manages a specified number of chunks as one container. Each container is identified with the chunk data set ID and each container includes a plurality of pieces of chunk data to which the chunk length is added. The chunk data set ID for identifying the container for the chunk data set 122 is associated with the chunk data set ID of the aforementioned chunk data set index 123.

The chunk index 125 stores the hash value (Fingerprint) of each chunk and the identification information (Chunk Data Set ID) of a container where the relevant chunk exists, by associating them with each other. The chunk index 125 is a table for judging in which container the relevant chunk is stored, based on the hash value calculated from each chunk when executing the deduplication processing.

The content which is backup data is divided into a plurality of chunks during the primary deduplication processing as described above. The content can include, besides normal files, for example, files such as archive files, backup files, or virtual volume files in which normal files are aggregated.

The deduplication processing is composed of processing for sequentially cutting chunks out of the content, processing for judging whether any duplication exists among the cutout chunks or not, and processing for storing and retaining the chunks. It is important to cut out as many data segments of the same content as possible during the chunk cutout processing in order to execute the deduplication processing efficiently.

Examples of the chunk cutout method include a fixed length chunk cutout method and a variable length chunk cutout method. The fixed length chunk cutout method is a method of sequentially cutting out chunks, each of which is of a fixed length such as 4 kilo-bytes (KB) or 1 mega-byte (MB). Furthermore, the variable length chunk method is a method of cutting the content by deciding boundaries for cutting out chunks based on local conditions of the content data.

Regarding the fixed length chunk cutout method, overhead for cutting out chunks is small; however, if a change of the content data is a change such as data insertion, the positions of chunks will move and the boundary positions at which chunks are cut out will change after the data insertion, thereby causing degradation of the deduplication efficiency. On the other hand, regarding the variable length chunk cutout method, the boundary positions for cutting out chunks will not change even if data is inserted and the positions of the chunks change, so that the deduplication efficiency can be enhanced; however, overhead of processing for searching for the chunk boundaries will increase. Furthermore, a basic data cutout method requires repetition of extension processing in order to cut out basic data, thereby causing a problem of an increase of the overhead for the deduplication processing.

Therefore, in consideration of a trade-off between the deduplication efficiency and the overhead for the deduplication processing, there has been a problem of the incapability to optimize the entire deduplication processing even if the deduplication processing is executed by using any one of the above-mentioned chunk cutout methods.

So, in this embodiment, an optimum chunk cutout method is selected according to the type of each content by switching a chunk cutout method to be applied during the chunk cutout processing based on the property of each content or each part of the content. The content type can be identified by detecting information for identifying the type attached to each content. The optimum chunk cutout method can be selected according to the type of the content by recognizing the property and structure of the content corresponding to the content type in advance.

For example, if certain content is of the type that rarely changes, chunks should preferably be cut out by applying the fixed length chunk cutout method to the relevant content. Moreover, in a case of the content of a large size, cutting out chunks of a large size will result in a small processing overhead; and in a case of the content of a small size, chunks of a small size should preferably be cut out. Furthermore, if there is any insertion into the content, chunks should preferably be cut out by applying the variable length chunk cutout method. When there is some insertion into the content, but changes are small, the processing efficiency can be enhanced and the management overhead can be reduced without degradation of the deduplication efficiency by cutting out chunks of a large chunk size.

Furthermore, the content having a specified structure can be divided into respective parts such as a header part, a body part, and a trailer part and a different cutout method is to be applied to each part. The deduplication efficiency and the processing efficiency can be optimized by applying a preferred chunk cutout method to each part.

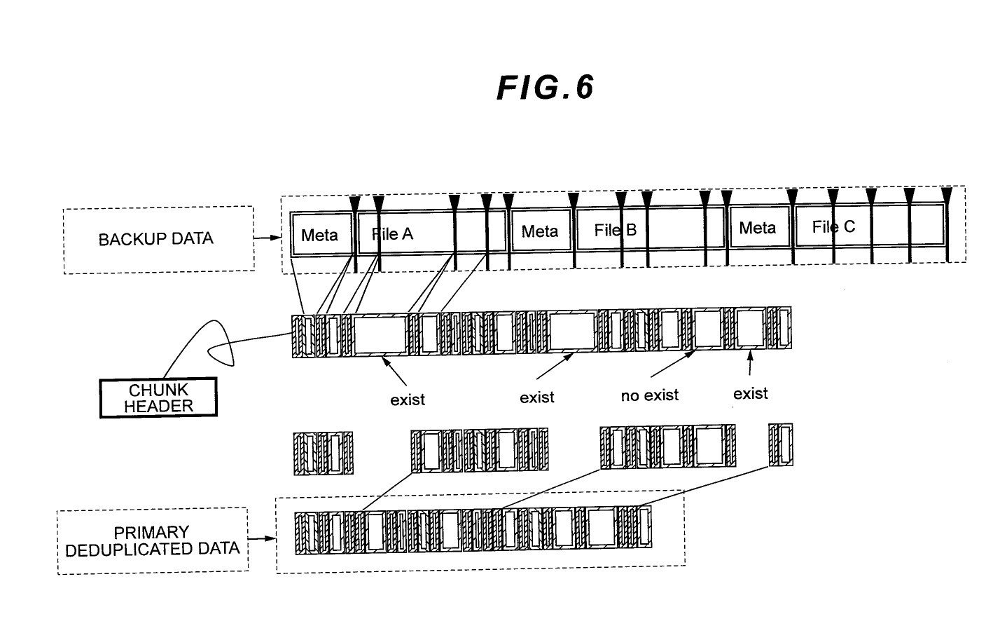

The primary deduplication processing unit 201 cuts the content into a plurality of chunks and compresses each chunk as described above. The primary deduplication processing unit 201 firstly divides the content into the header part (indicated as Meta in the drawing) and the body part (indicated as FileX in the drawing) as shown in FIG. 6. Then, the primary deduplication processing unit 201 further divides the body part by a fixed length or a variable length. If the content is divided by a fixed length, for example, chunks, each of which is of a fixed length such as 4 kilo-bytes (KB) or 1 mega-byte (MB), are cut out sequentially. Alternatively, if the content is divided by a variable length, boundaries for cutting out the chunks are decided based on local conditions of the content and the chunks are cut out. Furthermore, for example, files whose content structure rarely changes, such as vmdk files, vdi files, vhd files, zip files, or gzip files are divided by the fixed length and files other than those files are divided by the variable length.

Then, the primary deduplication processing unit 201 compresses the divided chunks and executes the primary deduplication processing on the chunks of low compressibility (chunks whose compressibility is lower than a threshold value). The primary deduplication processing unit 201 calculates a hash value of a target chunk of the primary duplication judgment processing and judges, based on the relevant hash value, whether the same chunk is already stored in the HDD 104. As a result of the execution of the primary deduplication processing, the primary deduplication processing unit 201 eliminates the chunk(s) already stored in the HDD 104 and generates primary deduplicated data to be stored in the first file system. The primary deduplication processing unit 201 adds the compression header, which indicates data information after the compression, to each compressed chunk and manages the chunks. Incidentally, during the primary deduplication processing (the in-line method), the hash value calculation and the deduplication processing are not executed on the chunks whose compressibility is higher than the threshold value.

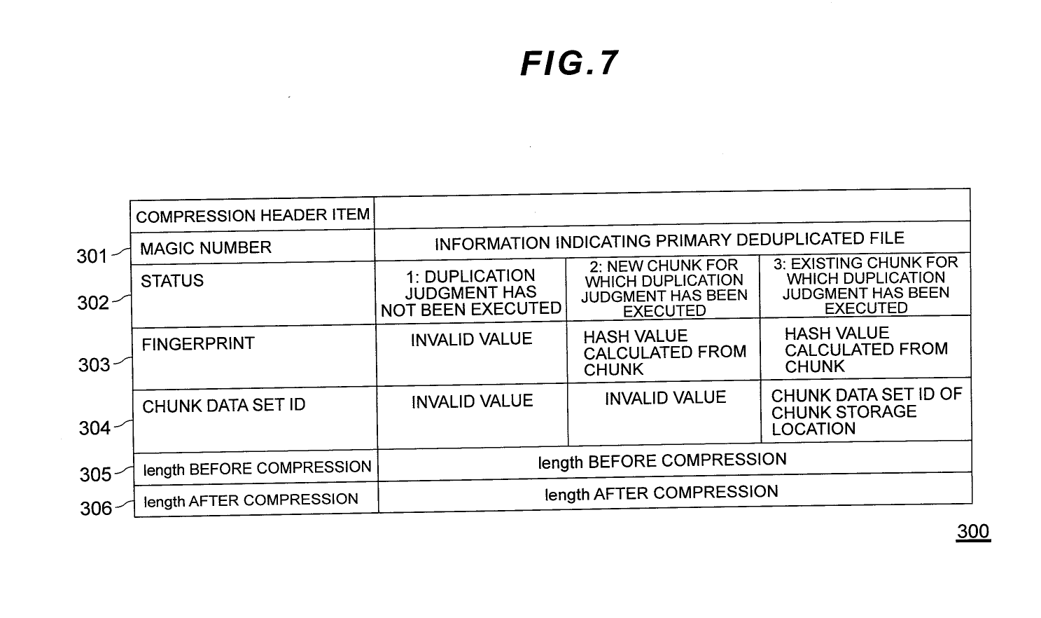

Next, the compression header of the chunk(s) will be explained. FIG. 7 is a conceptual diagram for explaining the compression header added to each compressed chunk. The compression header includes a magic number 301, status 302, a fingerprint 303, a chunk data set ID 304, length before compression 305, and length after compression 306 as shown in FIG. 7.

The magic number 301 stores information indicating that the primary deduplication processing has been executed on the relevant chunk. The status 302 stores information indicating whether the duplication judgment processing has been executed on the chunk. For example, if the status 302 stores Status 1, it indicates that the duplication judgment has not been executed. If the status 302 stores Status 2, it indicates that the relevant chunk is a new chunk on which the duplication judgment has been executed, and which has not been stored in the HDD 104, yet. Furthermore, if the status 302 stores Status 3, it indicates that the relevant chunk is an existing chunk on which the duplication judgment has been executed, and which is already stored in the HDD 104.

The fingerprint 303 stores the hash value calculated from the relevant chunk. Incidentally, during the primary deduplication processing, an invalid value is stored in the fingerprint 303 with respect to the chunk on which the duplication judgment processing has not been executed. Specifically speaking, the duplication judgment processing has not been executed on the chunk in Status 1, so that the invalid value is stored in the fingerprint 303.

The chunk data set ID 304 stores the chunk data set ID of a chunk storage location. The chunk data set ID 304 is information for identifying a container containing the relevant chunk (Chunk Data Set 122). Incidentally, an invalid value is stored in the chunk data set ID 304 with respect to a chunk(s) on which the primary deduplication processing has not been executed, and a new chunk(s) which has not been stored in the HDD 104, yet. Specifically speaking, the invalid value is stored in the chunk data set ID 304 of the chunk(s) in Status 1 or Status 2.

The length before compression 305 stores the chunk length before compression. The length after compression 306 stores the chunk length after compression.

The secondary deduplication processing unit 202 judges whether or not to execute the duplication judgment processing on each chunk, by referring to the compression header of the relevant chunk included in the primary deduplicated data generated by the primary deduplication processing unit 201. Specifically speaking, the secondary deduplication processing unit 202 judges whether or not to execute the duplication judgment processing, by referring to the status of the compression header of the chunk.

For example, if the status 302 of the compression header of the chunk is Status 1, it means that the duplication judgment processing was not executed during the primary deduplication processing; and, therefore, the duplication judgment processing is executed during the secondary deduplication processing. Furthermore, if the status 302 of the compression header of the chunk is Status 2, it means that the relevant chunk is a chunk on which the duplication judgment processing was executed during the primary duplication judgment processing, and which is not stored in the chunk data set 122; and, therefore, the storage location of the chunk is decided and the relevant chunk is written. Furthermore, if the status 302 of the compression header of the chunk is Status 3, it means that the relevant chunk is a chunk on which the duplication judgment processing was executed during the primary duplication judgment processing, and which is already stored in the chunk data set 122; and, therefore, the storage location of the chunk is obtained without executing the duplication judgment processing.

Of the deduplication processing, the primary deduplication processing unit 201 executes the division processing, which does not impose load, and the compression processing; and performs the calculation of the hash value and the duplication judgment processing on a chunk(s) of low compressibility as described above. Then, the secondary deduplication processing unit 202 refers to the compression header of each chunk and executes the duplication judgment processing on the chunk(s) on which the duplication judgment processing has not been executed by the primary deduplication processing unit 202. As a result, it is possible to reduce the load imposed by the duplication judgment processing and increase the speed of the data write processing. Furthermore, the consumption amount of the storage areas for temporarily storing data can be reduced by executing the deduplication processing on the chunk(s) of low compressibility (large data size) by the in-line method.

### (1-4) Deduplication Processing

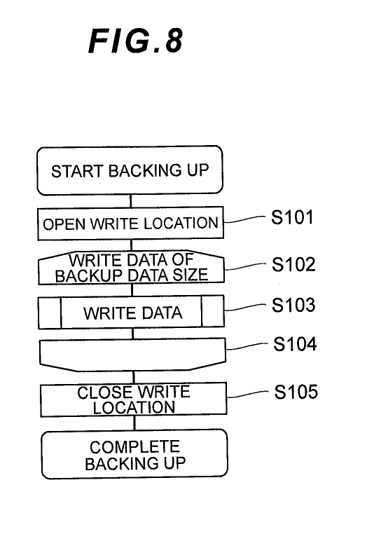

The deduplication processing according to this embodiment starts backing up data in response to a request from the host system 200. As illustrated in FIG. 8, the data backup processing in the storage apparatus 100 firstly opens a data write location (S101) and repeats processing for writing data of backup data size (S102 to S104). After terminating the data write processing, the storage apparatus 100 closes the write location (S105) and terminates the backup processing.

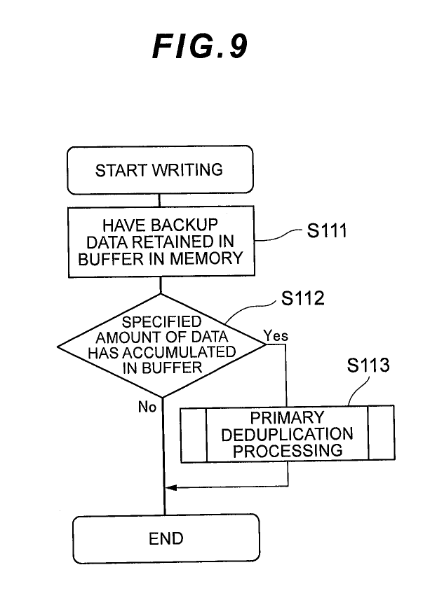

During the data write processing in step S103 described above, the storage apparatus 100 has the backup data from the host system 200 retained in a buffer in the memory (S111) as shown in FIG. 9.

Then, the storage apparatus 100 judges whether a specified amount of data have accumulated in the buffer or not (S112). If it is determined in step S112 that the specified amount of data have accumulated in the buffer, the primary deduplication processing unit 201 is made to execute the primary deduplication processing. On the other hand, it is determined in step S112 that the specified amount of data have not accumulated in the buffer, the storage apparatus 100 further receives backup data (S102).

### (1-4-1) Details of Primary Deduplication Processing

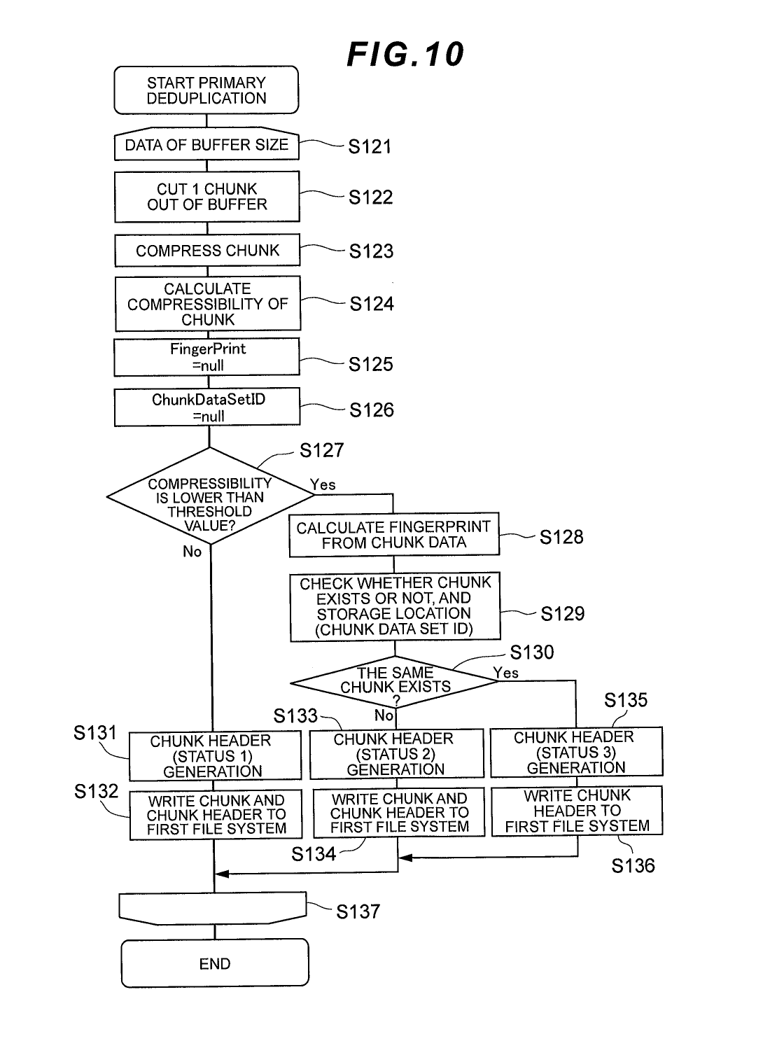

Next, the details of the primary deduplication processing by the primary deduplication processing unit 201 will be explained with reference to FIG. 10. The primary deduplication processing unit 201 repeats processing on the data retained in the buffer from step S121 to step S137 as many times as the number of chunks included in the buffer as shown in FIG. 10.

The primary deduplication processing unit 201 cuts out one chunk from the buffer by a fixed length or a variable length by the aforementioned division processing (S122). Then, the primary deduplication processing unit 201 compresses the chunk cut out in step S122 (S123) and calculates the compressibility of the chunk (S124).

Then, the primary deduplication processing unit 201 assigns a null value to the variable Fingerprint (S125) and assigns the null value to the variable Chunk Data Set ID (S126).

Subsequently, the primary deduplication processing unit 201 judges whether the compressibility of the chunk calculated in step S124 is lower than a specified threshold value or not (S127). A case where it is determined in step S127 that the compressibility of the chunk is lower than the specified threshold value is a case where the chunk length does not change much before and after the compression.

If it is determined in step S127 that the compressibility of the chunk is lower than the specified threshold value, the primary deduplication processing unit 201 executes processing in step S128 and subsequent steps. On the other hand, if it is determined in step S127 that the compressibility of the chunk is higher than the specified threshold value, the primary deduplication processing unit 201 executes processing in step S131 and subsequent steps.

In step S128, the primary deduplication processing unit 201 calculates a hash value from data of the chunk and assigns the calculation result to the variable Fingerprint (S128).

Then, the primary deduplication processing unit 201 checks if the relevant chunk is stored in a chunk data set by using the calculated hash value; and if the chunk is stored in the chunk data set, the primary deduplication processing unit 201 checks the chunk data set ID (Chunk Data Set ID) of the chunk data set (S129).

Then, the primary deduplication processing unit 201 judges whether the same chunk as the target chunk of the duplication judgment processing is stored in the chunk data set or not (S130). If it is determined in step S130 that the same chunk exists, the primary deduplication processing unit 201 executes processing in step S135 and subsequent steps. On the other hand, if it is determined in step S130 that the same chunk does not exist, the primary deduplication processing unit 201 executes processing in step S133 and subsequent steps.

If it is determined in step S127 that the compressibility is higher than the threshold value, the primary deduplication processing unit 201 does not execute the duplication judgment processing and generates the chunk header of Status 1 (S131). The chunk header of Status 1 means the compression header added to a chunk on which the duplication judgment has not been executed as described earlier. If the chunk header is Status 1 as shown in FIG. 7, the chunk and the chunk header are written to the first file system. It should be noted that since the duplication judgment processing has not been executed, the fingerprint 303 and the chunk data set ID 304 of the chunk header remain to be the null value.

Furthermore, if it is determined in step S127 that the compressibility is lower than the threshold value, and if it is then determined as a result of the execution of the duplication judgment processing that the same chunk does not exist in the chunk data set 122, the primary deduplication processing unit 201 generates a chunk header of Status 2 (S133). The chunk header of Status 2 means the compression header added to a chunk on which the duplication judgment has been executed, when the same chunk does not exist in the chunk data set 122. If the chunk header is Status 2 as shown in FIG. 7, the chunk and the chunk header are written to the first file system (S134). Incidentally, the hash value calculated from the chunk is stored in the fingerprint 303 of the chunk header. Also, since the same chunk has not been found yet, the chunk data set ID 304 remains to be the null value.

Furthermore, if it is determined in step S127 that the compressibility is lower than the threshold value and if it is determined as a result of the execution of the duplication judgment processing that the same chunk exists in the chunk data set 122, the primary deduplication processing unit 201 generates a chunk header of Status 3 (S135). The chunk header of Status 3 means the compression header added to a chunk on which the duplication judgment has been executed, when the same chunk exists in the chunk data set 122 as described earlier. If the chunk header is Status 3 as shown in FIG. 7, only the chunk header is written to the first file system (S136). Specifically speaking, data of the chunk itself will not be written to the first file system, thereby making it possible to reduce the storage capacity.

### (1-4-2) Details of Secondary Deduplication Processing

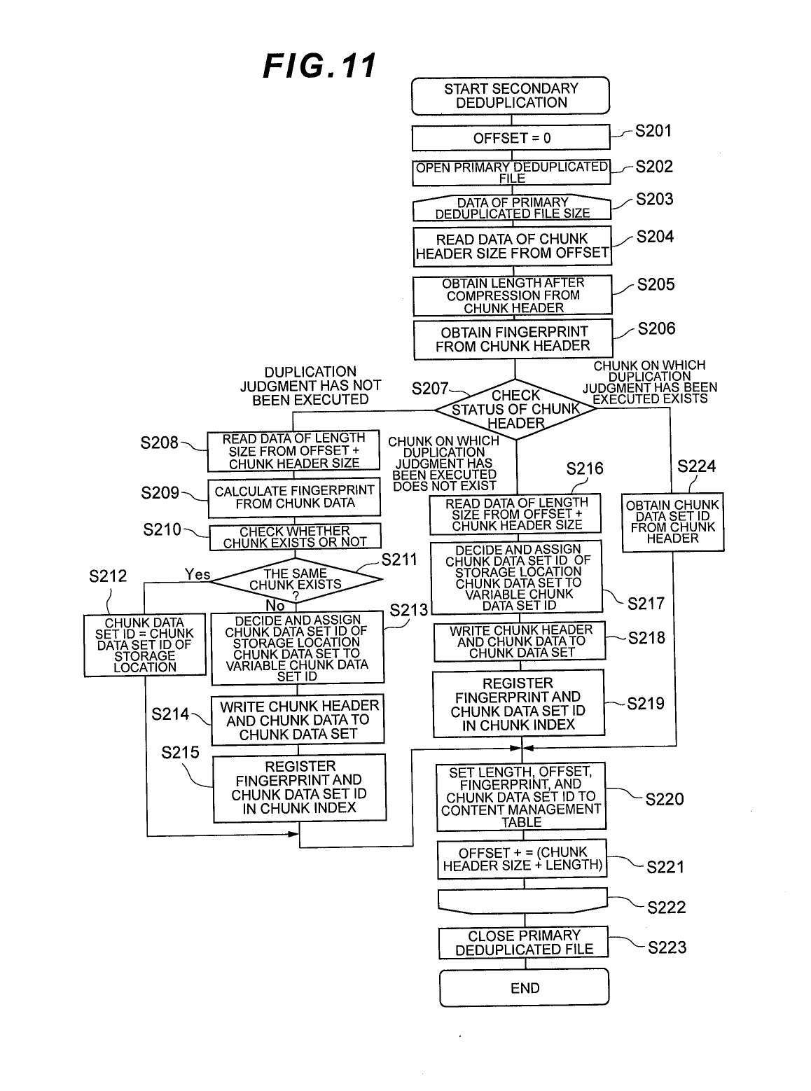

The details of the primary deduplication processing have been explained above. Next, the details of the secondary deduplication processing by the secondary deduplication processing unit 202 will be explained with reference to FIG. 11. The secondary deduplication processing may be executed periodically at specified time intervals, or may be executed at predetermined timing, or may be executed in response to input by the administrator. Furthermore, the execution of the secondary deduplication processing may be started when the capacity of the first file system exceeds a certain amount.

The secondary deduplication processing unit 202 firstly assigns 0 to the variable offset (S201) as illustrated in FIG. 11. Subsequently, the secondary deduplication processing unit 202 opens a primary deduplicated file(s) (the first file system) and repeats the secondary deduplication processing as many times as the number of the primary deduplicated files (S203 to S222).

The secondary deduplication processing unit 202, which opened the primary deduplicated file(s) in step S202, reads data of the chunk header size from the value assigned to the variable offset (S204). Then, the secondary deduplication processing unit 202 obtains the chunk length after compression from the value of the variable Length of the chunk header (S205). Furthermore, the secondary deduplication processing unit obtains the hash value (fingerprint) of the chunk from the variable Fingerprint of the chunk header (S206). Incidentally, if the primary duplication judgment processing has not been executed during the primary deduplication processing, the invalid value (null) is stored in the Fingerprint of the chunk header.

Subsequently, the secondary deduplication processing unit 202 checks the status (Status) included in the chunk header of the chunk (S207). If the status is Status 1 in step S207, that is, if the duplication judgment has not been executed on the target chunk, the secondary deduplication processing unit 202 executes the processing in step S208 and subsequent steps. Furthermore, if the status is Status 2 in step S207, that is, if the duplication judgment has been executed on the target chunk by the primary deduplication processing, but the same chunk does not exist in the chunk data set 122, the secondary deduplication processing unit 202 executes the processing in step S216 and subsequent steps without executing the deduplication processing. Furthermore, if the status is Status 3 in step S207, that is, if the duplication judgment has been executed on the target chunk by the primary deduplication processing and the same chunk exists in the chunk data set 122, the secondary deduplication processing unit 202 executes the processing in step S224 and subsequent steps without executing the deduplication processing.

Next, the processing in the case where the status of the chunk header is Status 1, that is, the case where the duplication judgment has not been executed will be explained. The secondary deduplication processing unit 202 reads data of the length obtained by adding the chunk header size to the offset value (S208). Then, the secondary deduplication processing unit 202 calculates a hash value (Fingerprint) from the chunk data read in step S208 (S209).

Then, the secondary deduplication processing unit 202 checks if a chunk of a chunk data set 122 exists or not, based on the Fingerprint calculated in step S209 (S210) and judges whether or not the same chunk as the target chunk exists in the chunk data set 122 (S211).

If it is determined in step S211 that the same chunk exists in the chunk data set 122, the secondary deduplication processing unit 202 assigns the same ID as the chunk data set ID (Chunk Data Set ID) of the storage location of the same chunk, which is already stored, to the variable Chunk Data Set ID (S212) and executes processing in step S220 and subsequent steps.

On the other hand, if it is determined in step S211 that the same chunk does not exist in the chunk data set 122, the secondary deduplication processing unit 202 decides a chunk data set (Chunk Data Set) 122, which is a storage location to store the chunk, and assigns the chunk data set ID of the decided chunk data set 122 to the variable Chunk Data Set ID (S213).

Then, the secondary deduplication processing unit 202 writes the chunk header and the chunk data to the chunk data set (Chunk Data Set) 122 (S214). Furthermore, the secondary deduplication processing unit 202 registers the value, which was assigned to the variable Fingerprint in step S209, and the value, which was assigned to the variable Chunk Data Set ID in step S213, in the chunk index 125 (S215) and executes processing in step S220 and subsequent steps.

Next, processing for the case where the status of the chunk header is Status 2, that is, the case where the duplication judgment has been executed, but the same chunk does not exist in the chunk data set 122 will be explained. The secondary deduplication processing unit 202 reads data of the length obtained by adding the chunk header size to the offset value (S216).

Then, the secondary deduplication processing unit 202 decides a chunk data set (Chunk Data Set) 122, which is the storage location to store the chunk, and assigns the chunk data set ID of the decided chunk data set 122 to the variable Chunk Data Set ID (S217).

Then, the secondary deduplication processing unit 202 writes the chunk header and the chunk data to the chunk data set (Chunk Data Set) 122 (S218). Furthermore, the secondary deduplication processing unit 202 registers the value, which was assigned to the Fingerprint in step S206, and the value, which was assigned to the variable Chunk Data Set ID in step S217, in the chunk index 125 (S219) and executes the processing in step S220 and subsequent steps.

Next, processing for the case where the status of the chunk header is Status 3, that is, the case where the duplication judgment has been executed and the same chunk exists in the chunk data set 122 will be explained. The secondary deduplication processing unit 202 obtains the chunk data set ID (Chunk Data Set ID) from the chunk header and assigns it to the variable Chunk Data Set ID (S224). Then, the secondary deduplication processing unit 202 executes the processing in step S220 and subsequent steps. It should be noted that the chunk data set ID (Chunk Data Set ID) stored in the chunk header is the same data as the data deduplicated by the primary deduplication processing and is an ID indicating the storage location of the already stored data.

Then, the secondary deduplication processing unit 202 sets the chunk length (Length), the offset (Offset), the fingerprint (Fingerprint), and the chunk data set ID (Chunk Data Set ID) to the content management table 124 (S220).

Then, the secondary deduplication processing unit 202 adds the chunk header size and the chunk length (Length) to the value of the variable Offset and assigns it to the variable Offset (S221).

After repeating the processing from step S203 to step S22 as many times as the number of chunks included in the primary deduplicated file, the secondary deduplication processing unit 202 closes the primary deduplicated file(s) (S223) and terminates the secondary deduplication processing.

### (1-5) Details of Read Processing

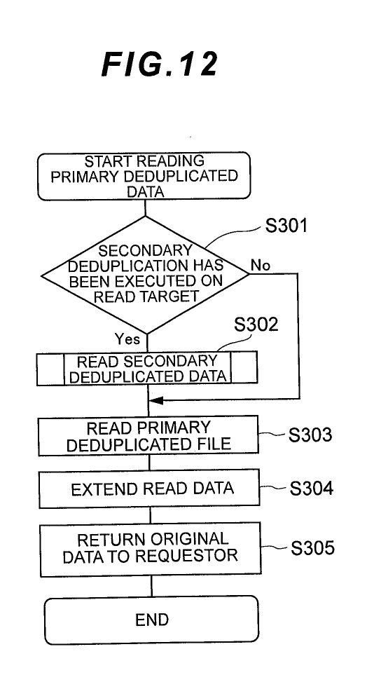

Next, processing for reading data on which the primary deduplication processing and the secondary deduplication processing have been executed will be explained with reference to FIG. 12. The processing for reading the deduplicated data is executed by the primary deduplication processing unit 201 and the secondary deduplication processing unit 202.

As depicted in FIG. 12, the primary deduplication processing unit 202 firstly judges whether a read target is secondary deduplicated data or not (S301). For example, if the relevant data is formed as a stub, the primary deduplication processing unit 202 determines that the relevant data is the secondary deduplicated data.

If it is determined in step S301 that the read target data is the secondary deduplicated data, the primary deduplication processing unit 202 executes processing for reading the secondary deduplicated data (S302). On the other hand, if it is determined in step S301 that the read target data is not the secondary deduplicated data, the primary deduplication processing unit 202 executes processing in step S303 and subsequent steps.

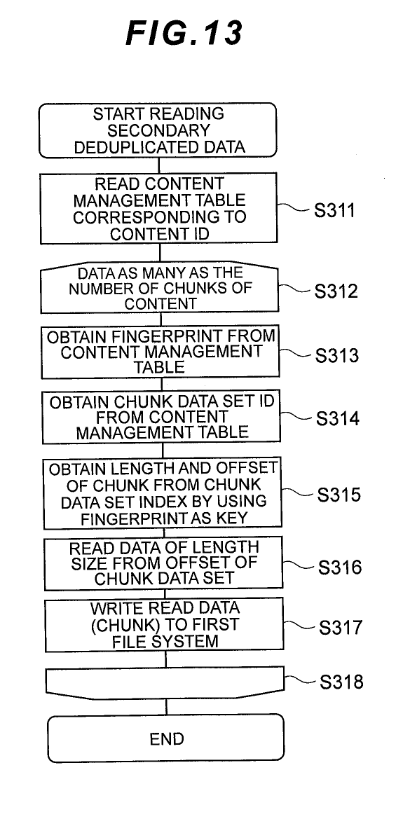

FIG. 13 illustrates the details of the processing for reading the secondary deduplicated data. As depicted in FIG. 13, the secondary deduplication processing unit 202 reads the content management table 124 corresponding to the content ID (content ID) of content data (S311).

Then, the secondary deduplication processing unit 202 repeats processing from step S312 to step S318 as many times as the number of chunks of the content.

The secondary deduplication processing unit 202 firstly obtains a fingerprint (Fingerprint) from the content management table 124 (S313). Furthermore, the secondary deduplication processing unit 202 obtains a chunk data set ID (Chunk Data Set ID) from the content management table 124 (S314).

Then, the secondary deduplication processing unit 202 obtains a chunk length (Length) and offset (Offset) of the chunk from the chunk data set index (Chunk Data Set Index) 123 by using the fingerprint (Fingerprint) obtained in step S313 as a key (S315).

Then, the secondary deduplication processing unit 202 reads data of the chunk length (Length) from the offset (Offset) of the chunk data set obtained in step S315 (S316). Then, the secondary deduplication processing unit 202 writes the chunk data, which was read in step S316, to the first file system (S317).

Referring back to FIG. 12, after the execution of the processing for reading the secondary deduplicated data in step S302, the primary deduplication processing unit 201 reads a primary deduplicated file (S303).

Then, the primary deduplication processing unit 201 extends the data which was read in step S303 (S304). Then, the primary deduplication processing unit 201 returns the original data before compression to a data requestor such as the host system 200 which requested the data (S305). The processing for reading the deduplicated data has been described above.

### (1-6) Advantageous Effects of this Embodiment

According to this embodiment as described above, the primary deduplication processing unit 201 divides data from the host system 200 into one or more chunks and compresses the divided chunk(s); and if the compressibility of the chunk is lower than a specified threshold value, the primary deduplication processing unit 201 calculates a hash value of the relevant chunk, compares the hash value with a hash value of data already stored in the HDD 104 and executes the first deduplication processing; and if the compressibility of the chunk is higher than the specified threshold value, the primary deduplication processing unit 201 stores the relevant compressed chunk in the first file system and then the secondary deduplication processing unit 202 calculates a hash value of the compressed chunk, compares the relevant hash value with a hash value of data already stored in the HDD 104, and executes the secondary deduplication processing.

As a result, the processing of the deduplication processing for dividing data with a small processing load can be executed during the primary deduplication processing; and whether the relevant chunk should be deduplicated by the primary deduplication processing or the deduplication processing should be executed by the secondary deduplication processing can be decided based on the compressibility of the chunk. So, the deduplication processing can be executed efficiently in consideration of the respective advantages of the primary deduplication processing and the secondary deduplication processing.

### (2) Second Embodiment

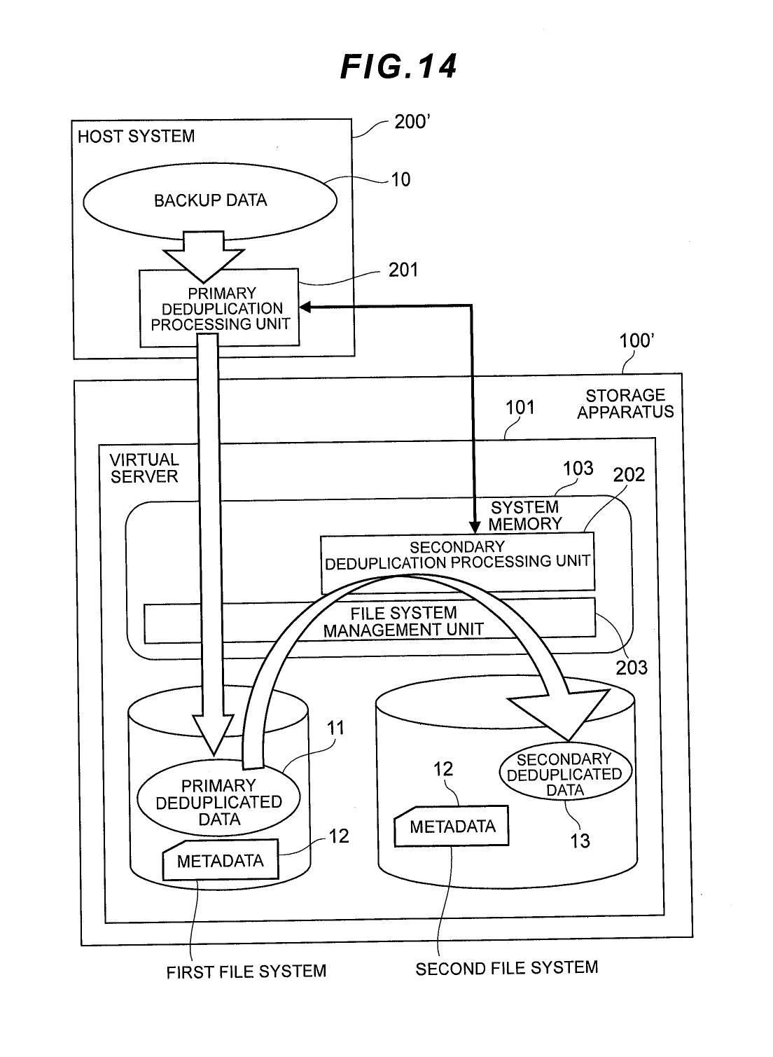

Next, the second embodiment will be explained with reference to FIG. 14. The detailed explanation has been omitted about the same configuration as that of the first embodiment described above and the configuration different from that of the first embodiment will be explained particularly in detail in the following explanation. Since the hardware configuration of a computer system is the same as that of the first embodiment, its detailed explanation has been omitted.

(2-1) Software Configuration of Host System and Storage Apparatus

This embodiment is configured as depicted in FIG. 14 that a host system 200′ is equipped with a primary deduplication processing unit 201 and a storage apparatus 100′ is equipped with a secondary deduplication processing unit 202. The host system 200′ may be a server such as a backup server, or another storage apparatus.

When backing up data, the amount of data from the host system 200′ to the storage apparatus 100′ can be reduced by executing the primary deduplication processing at the host system 200′. For example, when the throughput of the host system 200′ is high and the transfer capability between the host system 200′ and the storage apparatus 100′ is low, the configuration like that of this embodiment should preferably be employed.

### REFERENCE SIGNS LIST

100 storage apparatus
101 virtual server
103 system memory
105 Fibre Channel port
106 Fibre Channel cable
110 disk array device
121 stub file
122 chunk data set
123 chunk data set index
124 content management table
125 chunk index
200 host system
201 primary deduplication processing unit
202 secondary deduplication processing unit
203 file system management unit

1. A storage apparatus comprising:
a storage device providing a first storage area and a second storage area; and
a control unit for controlling data input to and output from the storage device;
wherein the control unit divides received data into one or more chunks, and
compresses the divided chunk or chunks; and
regarding the chunk whose compressibility is equal to or lower than a threshold value, the control unit does not store the chunk in the first storage area, but calculates a hash value of the compressed chunk, compares the hash value with a hash value of another data already stored in the second storage area, and executes first deduplication processing; and
regarding the chunk whose compressibility is higher than the threshold value, the control unit stores the compressed chunk in the first storage area, then reads the compressed chunk from the first storage area, calculates a hash value of the compressed chunk, compares the relevant hash value with a hash value of another data already stored in the second storage area, and executes secondary deduplication processing.

2. The storage apparatus according to claim 1, wherein the control unit:
associates the first storage area with a first file system and associates the second storage area with a second file system;
stores a chunk which cannot be deduplicated by the first deduplication processing and a chunk whose compressibility is higher than the threshold value, in the first file system; and
stores the chunk, which is stored in the first file system and on which the second deduplication processing is executed, in the second file system.

3. The storage apparatus according to claim 2, wherein the control unit adds a compression header including information indicating whether the first deduplication processing has been executed or not, to the compressed chunk and stores it in the first file system; and
if the first deduplication processing has not been executed with reference to the compression header, the control unit executes the second deduplication processing on the chunk.

4. The storage apparatus according to claim 3, wherein if the first deduplication processing has not been executed on the chunk, the control unit sets a first flag to the compression header;
if the first deduplication processing is executed on the chunk and another data whose hash value is identical to the hash value of the relevant chunk is not stored in the second storage area, the control unit sets a second flag to the compression header; and
if the first deduplication processing is executed on the chunk and another data whose hash value is identical to the hash value of the relevant chunk is stored in the second storage area, the control unit sets a third flag to the compression header.

5. The storage apparatus according to claim 4, wherein if the first flag is set to the compression header, the control unit stores the chunk and the compression header of the relevant chunk in the first file system;
if the second flag is set to the compression header, the control unit stores the chunk and the compression header of the relevant chunk in the first file system; and
if the third flag is set to the compression header, the control unit stores only the compression header of the chunk in the first file system.

6. The storage apparatus according to claim 4, wherein if the first flag is set to the compression header, the control unit executes the second deduplication processing on the chunk;
if the second flag is set to the compression header, the control unit stores the chunk in the second storage area; and
if the third flag is set to the compression header, the control unit obtains a storage location of the chunk in the second storage area.

7. A data management method for a storage apparatus including a storage device providing a first storage area and a second storage area, and a control unit for controlling data input to and output from the storage device,
the data management method comprising:
a first step executed by the control unit dividing received data into one or more chunks and compressing the divided chunk or chunks; and
a second step executed, regarding the chunk whose compressibility is equal to or lower than a threshold value, by the control unit not storing the chunk in the first storage area, but calculating a hash value of the compressed chunk, comparing the hash value with a hash value of another data already stored in the second storage area, and executing first deduplication processing; and
a third step executed, regarding the chunk whose compressibility is higher than the threshold value, by the control unit storing the compressed chunk in the first storage area, then reading the compressed chunk from the first storage area, calculating a hash value of the compressed chunk, comparing the relevant hash value with a hash value of another data already stored in the second storage area, and executing secondary deduplication processing.

8. The data management method according to claim 7, wherein the first storage area is associated with a first file system and the second storage area is associated with a second file system; and
wherein the data management method further comprises:
a fourth step executed in the second step by the control unit storing a chunk which cannot be deduplicated by the first deduplication processing and a chunk whose compressibility is higher than the threshold value, in the first file system; and
a fifth step executed in the third step by the control unit storing the chunk, which is stored in the first file system and on which the second deduplication processing is executed, in the second file system.

9. The data management method according to claim 8, further comprising:
a sixth step executed in the fourth step by the control unit adding a compression header including information indicating whether the first deduplication processing has been executed or not, to the compressed chunk and storing it in the first file system; and
a seventh step executed, if the first deduplication processing has not been executed with reference to the compression header, by the control unit executing the second deduplication processing on the chunk.

10. The data management method according to claim 9, further comprising an eighth step executed by the control unit:
setting a first flag to the compression header if the first deduplication processing has not been executed on the chunk;
setting a second flag to the compression header if the first deduplication processing is executed on the chunk and another data whose hash value is identical to the hash value of the relevant chunk is not stored in the second storage area; and
setting a third flag to the compression header if the first deduplication processing is executed on the chunk and another data whose hash value is identical to the hash value of the relevant chunk is stored in the second storage area.

11. The data management method according to claim 10, further comprising a ninth step executed by the control unit:
storing the chunk and the compression header of the relevant chunk in the first file system if the first flag is set to the compression header;
storing the chunk and the compression header of the relevant chunk in the first file system if the second flag is set to the compression header; and
storing only the compression header of the chunk in the first file system if the third flag is set to the compression header.

12. The data management method according to claim 10, further comprising a tenth step executed by the control unit:
executing the second deduplication processing on the chunk if the first flag is set to the compression header;
storing the chunk in the second storage area if the second flag is set to the compression header; and
obtaining a storage location of the chunk in the second storage area if the third flag is set to the compression header.
